(19) United States
(12) Patent Application Publication
(10) Pub. No.: US 2026/0329278 A1
(43) Pub. Date: Oct. 22, 2026

(54) INTEGRATION OF PLASMONIC ANTENNAS WITH ROBOTIC VEHICLES FOR COMMUNICATION AND SENSING

(71) Applicant: Saltenna Inc., McLean, VA (US)

(72) Inventors: Igor SMOLYANINOV, Columbia, MD (US); Quirino Balzano, Annapolis, MD (US); Sanjee Singla, Washington, DC (US)

(21) Appl. No.: 19/649,993

(22) Filed: Apr. 16, 2026

Related U.S. Application Data
(60) Provisional application No. 63/789,914, filed on Apr. 16, 2025.

(51) Int. Cl. G05D 1/242; G01N 22/00; G05D 1/69; G05D 111/30; H01Q 1/27

(52) U.S. Cl. CPC G05D 1/242; G01N 22/00; G05D 1/69; H01Q 1/27; G05D 2111/30

(57) ABSTRACT

Methods, systems, and devices for using plasmonic antennas integrated with robotic vehicles for communication and sensing are described. In some implementations, a robotic vehicle may receive data indicative of its operational environment, the vehicle including a plasmonic antenna mounted on a structure configured to contact a surface. Control signals may be transmitted to the robotic vehicle to activate the plasmonic antenna for surface electromagnetic wave propagation along the surface. Signals received from the plasmonic antenna may be processed to determine communication or sensing data associated with the operational environment. The communication or sensing data may be stored in a memory for subsequent analysis or use, enabling enhanced functionality in challenging environments such as tunnels, pipes, or areas with physical obstructions and electromagnetic interference.

### FIELD OF TECHNOLOGY

The present disclosure relates generally to communication systems, and more specifically to integration of plasmonic antennas with robotic vehicles for communication and sensing.

### BACKGROUND

Robotic vehicles, including unmanned aerial vehicles, unmanned ground vehicles, and robotic dogs, may operate in diverse fields such as search and rescue, surveillance, and exploration. These vehicles may be deployed in areas with physical obstructions, such as tunnels, pipes, or enclosed spaces.

### SUMMARY

The described techniques relate to improved methods, systems, devices, and apparatuses that support techniques for integration of plasmonic antennas with robotic vehicles for communication and sensing. Some implementations integrate plasmonic antennas into robotic vehicles, enabling surface electromagnetic wave propagation for communication and sensing. These antennas may be strategically mounted on robotic structures, such as legs, feet, nose, movable arms, wheels, tracks, or other structures that may be put into contact with a surface such as the ground or a wall. This may facilitate robotic vehicle operations in environments with physical obstructions or electromagnetic interference.

By utilizing flexible substrates for antenna fabrication, some implementations may ensure conformal integration of antennas into robotic vehicles, maintaining functionality on irregular surfaces. The system may leverage advanced signal propagation techniques to enable communication around corners, over metal barriers, and in non-line-of-sight scenarios. Additionally, onboard sensors and signal processing units may allow robotic vehicles to detect objects, classify materials, and perform imaging tasks through obstacles. This integration may support coordinated missions involving multiple robotic vehicles, providing a robust solution for operations in environments where conventional methods may be ineffective.

A system for plasmonic communications and sensing with robotic vehicles is described. The system may include a plasmonic antenna configured to be mounted on a structure of a robotic vehicle, the structure of the robotic vehicle may be configured to position the plasmonic antenna at or near a surface, the plasmonic antennas may be configured to induce and/or capture surface electromagnetic waves propagating along the surface. The system may include a communication module operatively connected to the plasmonic antenna, the communication module may be configured to transmit and/or receive signals through the plasmonic antennas.

A method for plasmonic communications and sensing with robotic vehicles is described. The method may include mounting a plasmonic antenna on a structure of a robotic vehicle, wherein the structure of the robotic vehicle may position the plasmonic antenna at or near a surface, and wherein the plasmonic antenna may induce and/or capture surface electromagnetic waves propagating along the surface. The method may include operatively connecting a communication module to the plasmonic antenna, wherein the communication module may transmit and/or receive signals through the plasmonic antennas.

In some examples of the technologies and related methods described herein, the plasmonic antenna may be fabricated on a flexible substrate. The flexible substrate may be configured to conform to a contour of the structure of the robotic vehicle.

In some examples of the technologies and related methods described herein, the plasmonic antenna may include copper strips. The copper strips may be configured to enhance the induction and/or capture of surface electromagnetic waves propagating along the surface.

Some examples of the technologies and related methods described herein may further include a coaxial cable operatively connected to the communication module. The coaxial cable may be configured to transmit signals between the communication module and the plasmonic antenna.

In some examples of the technologies and related methods described herein, the structure of the robotic vehicle may be configured to position the plasmonic antenna near conducting surfaces. The conductor surfaces may be configured to support the propagation of surface electromagnetic waves.

Some examples of the technologies and related methods described herein may further include a tuning mechanism operatively connected to the plasmonic antenna. The tuning mechanism may be configured to adjust the operational frequency of the plasmonic antenna.

In some examples of the technologies and related methods described herein, the structure of the robotic vehicle may include a mounting location near conducting surfaces. The mounting location may be configured to position the plasmonic antenna to induce surface electromagnetic waves along the conductor surfaces.

In some examples of the technologies and related methods described herein, the plasmonic antenna may be a flexible 433 MHz plasmonic antenna. The flexible 433 MHz plasmonic antenna may be configured to operate with multiple radio systems to facilitate communication in environments with significant electromagnetic interference.

In some examples of the technologies and related methods described herein, the communication module may be configured to analyze signals received by the plasmonic antenna. The signals may be analyzed to detect objects based on their dielectric properties.

In some examples of the technologies and related methods described herein, the plasmonic antenna may be configured to transfer signals along a surface in response to the robotic vehicle encountering a non-line-of-sight scenario.

In some examples of the technologies and related methods described herein, the plasmonic antenna may be configured to establish communication over a metal barrier in response to the robotic vehicle being positioned near the metal barrier.

In some examples of the technologies and related methods described herein, the plasmonic antenna may operate in conjunction with one or more other plasmonic antennas to perform sensing tasks by inducing and receiving surface electromagnetic waves along a conductive surface such as a metal barrier. The sensing tasks may classify materials based on their dielectric properties.

In some examples of the technologies and related methods described herein, the plasmonic antenna may be configured to be mounted near conducting surfaces. The mounting may enable communication and sensing tasks in environments with free space signal attenuation.

A method for using plasmonic antennas integrated with robotic vehicles for communication and sensing is described. The method may include receiving data indicative of a robotic vehicle's operational environment, the robotic vehicle including a plasmonic antenna mounted on a structure configured to contact a surface. The method may include transmitting control signals to the robotic vehicle to activate the plasmonic antenna for surface electromagnetic wave propagation along the surface. The method may include processing signals received from the plasmonic antenna to determine communication or sensing data associated with the operational environment. The method may include storing the communication or sensing data in a memory for subsequent analysis or use.

A system configured for using plasmonic antennas integrated with robotic vehicles for communication and sensing is described. The system may include a processor. The system may include memory coupled with the processor. The system may include instructions stored in the memory and executable by the processor to cause the system to receive data indicative of a robotic vehicle's operational environment, the robotic vehicle including a plasmonic antenna mounted on a structure configured to contact a surface. The system may include instructions to transmit control signals to the robotic vehicle to activate the plasmonic antenna for surface electromagnetic wave propagation along the surface. The system may include instructions to process signals received from the plasmonic antenna to determine communication or sensing data associated with the operational environment. The system may include instructions to store the communication or sensing data in the memory for subsequent analysis or use.

### BRIEF DESCRIPTION OF THE DRAWINGS

FIG. 1 illustrates a system that demonstrates the concept of surface electromagnetic waves (SEWs), in accordance with one or more implementations.

FIG. 2 shows a robotic vehicle environment which supports techniques for integration of plasmonic antennas with robotic vehicles for communication and sensing in accordance with various aspects of the present disclosure.

FIG. 3 shows robotic vehicles which supports techniques for integration of plasmonic antennas with robotic vehicles for communication and sensing in accordance with various aspects of the present disclosure.

FIG. 4 shows a robotic dog environment which supports techniques for integration of plasmonic antennas with robotic vehicles for communication and sensing in accordance with various aspects of the present disclosure.

FIG. 5 shows flexible plasmonic antenna which supports techniques for integration of plasmonic antennas with robotic vehicles for communication and sensing in accordance with various aspects of the present disclosure.

FIG. 6 shows a graph illustrating the S11 return loss (dB) as a function of frequency (MHz) in accordance with various aspects of the present disclosure.

FIG. 7 shows a block diagram of an apparatus that supports integration of plasmonic antennas with robotic vehicles for communication and sensing in accordance with various aspects of the present disclosure.

FIG. 8 shows a block diagram of a plasmonic communication component that supports integration of plasmonic antennas with robotic vehicles for communication and sensing in accordance with various aspects of the present disclosure.

FIG. 9 shows a diagram of a system including a device that supports integration of plasmonic antennas with robotic vehicles for communication and sensing in accordance with various aspects of the present disclosure.

FIGS. 10 and 11 show flowcharts illustrating methods that support integration of plasmonic antennas with robotic vehicles for communication and sensing in accordance with various aspects of the present disclosure.

### DETAILED DESCRIPTION

Devices, apparatuses, systems, and methods that support techniques for integration of plasmonic antennas with robotic vehicles for communication and sensing are disclosed. In some examples, conventional communication and sensing technologies used in robotic vehicles may be unreliable in environments with physical obstructions, electromagnetic interference, or non-line-of-sight conditions. These limitations may hinder the ability of robotic vehicles to maintain communication, detect objects, or perform imaging tasks in complex environments such as tunnels, pipes, or areas surrounded by metal barriers. Additionally, the integration of antennas and sensors into robotic vehicles may lack adaptability to irregular surfaces or compact spaces, further restricting their functionality in challenging scenarios. There may be a need for innovative solutions to enhance the operational capabilities of robotic vehicles in these scenarios.

According to some implementations, plasmonic communication systems may integrate specialized antennas into robotic vehicles to facilitate communication and sensing in environments with obstructions or interference. These antennas may utilize surface electromagnetic wave propagation, which involves transmitting signals along conductive surfaces, allowing communication to occur around corners, through barriers, and in scenarios where direct line-of-sight may be unavailable.

The antennas may be fabricated on flexible materials, enabling them to conform to the contours of robotic structures. This flexibility may allow the antennas to function effectively on irregular surfaces and in compact or uniquely shaped areas. The antennas may be strategically mounted on various parts of robotic vehicles to optimize their performance. For example, robotic dogs may have antennas integrated into their legs or feet, which may enable communication through the ground or conductive surfaces as they move. Alternatively, antennas may be mounted on the nose of robotic dogs, which may allow them to establish communication or sensing when in contact with walls, pipes, or other surfaces. Robotic vehicles may include movable arms equipped with antennas, which may be positioned precisely for communication or sensing tasks. For unmanned ground vehicles, antennas may be integrated into wheels or tracks to facilitate communication through the ground or to detect objects buried beneath the surface. Unmanned aerial vehicles may have antennas mounted on structural components such as arms or extensions, which may enable them to direct signals toward specific surfaces.

Robotic vehicles may include a communication module equipped with radio frequency transceivers to transmit and receive signals via the antennas. These modules may ensure reliable communication in environments such as tunnels, pipes, or areas with interference. The antennas may be designed to operate across a wide range of frequencies, which may allow compatibility with various communication and sensing applications.

Robotic vehicles may include sensors capable of detecting the dielectric properties of materials. These sensors, in combination with the antennas, may enable tasks such as detecting objects behind barriers, classifying materials based on their dielectric properties, and imaging through obstacles. Signal processing units may analyze the received signals to extract information about the environment or objects of interest.

The robotic vehicles may be powered by onboard energy systems that may provide power to the antennas, communication modules, and sensors. Antenna control systems may manage the operation of the antennas, including adjusting their frequency and optimizing their performance for specific tasks.

Some implementations may support coordinated missions involving multiple robotic vehicles. For example, an unmanned aerial vehicle may deploy smaller robotic vehicles, such as robotic dogs or ground vehicles, each equipped with plasmonic antennas. These vehicles may operate independently or collaboratively to perform communication and sensing tasks in complex environments.

The plasmonic antennas may be designed with specific geometries to optimize their performance. For example, they may include flexible copper strips mounted on a flexible substrate, with tuning points to adjust their frequency. These designs may maximize the propagation of surface electromagnetic waves, which may ensure effective communication and sensing.

Some implementations may enhance the operational capabilities of robotic vehicles in environments such as tunnels, pipes, areas with interference, or locations surrounded by barriers. Robotic vehicles may navigate through these environments while maintaining communication with external operators. They may establish communication or perform sensing tasks by directing antennas toward specific surfaces or detecting objects buried beneath the surface.

The antennas may be adaptable to various operational needs, including communication in scenarios without direct line-of-sight, sensing and imaging through obstacles, and deployment in compact or irregularly shaped areas. Their flexible and conformal design may ensure compatibility with a wide range of robotic platforms and environments.

Some implementations may support advanced mission capabilities, such as deploying smaller robotic vehicles from a larger aerial vehicle and enabling collaborative operations to achieve mission objectives. The antennas may be designed to integrate seamlessly into robotic vehicles without interfering with their primary functions, which may ensure structural integrity and operational efficiency.

Aspects of the subject matter described in this disclosure can be implemented to realize one or more of the following potential advantages. The described techniques may be implemented to support enhanced operational security by enabling communication and sensing through barriers that may otherwise block conventional signals. The systems may allow for the detection and classification of materials or objects in environments where traditional methods may fail due to interference or obstructions. The flexible and conformal design of the antennas may facilitate their integration into robotic platforms without compromising their mobility or structural integrity. The described configurations may enable robotic vehicles to perform tasks in environments with limited accessibility, such as confined spaces or areas with complex geometries. The ability to propagate signals along conductive surfaces may provide a robust solution for maintaining communication in scenarios where free-space transmission may be unreliable, impractical or unrealizable.

Aspects of the disclosure are initially described in the context of plasmonic communication systems. Aspects of the disclosure are additionally illustrated by and described with reference to example implementations. Aspects of the disclosure are further illustrated by and described with reference to a flowchart that relates to methods involving integration of plasmonic antennas with robotic vehicles for communication and sensing.

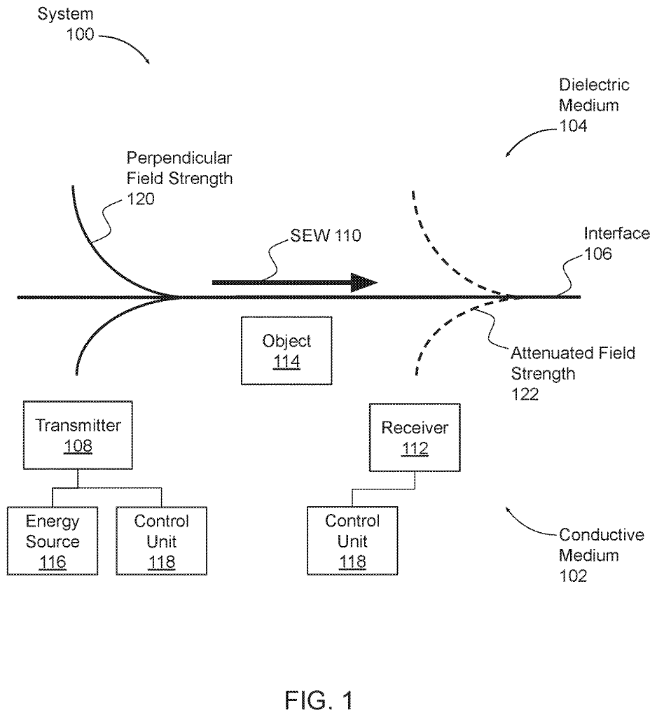

FIG. 1 illustrates a system 100 that demonstrates the concept of surface electromagnetic waves (SEWs), in accordance with one or more implementations. The system 100 may include a conductive medium 102, such as a body of water, organic tissue, a metallic plane, and/or other conductive media. Adjacent to the conductive medium 102, there may be a dielectric medium 104, such as air and/or other dielectric media, which may interface with the conductive medium 102. The interface 106 between the conductive medium 102 and the dielectric medium 104 may be where SEWs are generated and may propagate.

The system 100 may also include a transmitter 108, which may be positioned near the interface 106. The transmitter 108 may be positioned within the conductive medium 102 or within the dielectric medium 104. The transmitter 108 may be responsible for generating an electromagnetic field that may induce SEWs at the interface 106 of the conductive medium 102 and the dielectric medium 104. The excited SEWs may then travel along the interface 106, as indicated by the arrow of SEW 110, which may represent the direction of wave propagation.

To help visualize the phenomenon of SEWs, one may consider an analogy to ripples on a pond. When a stone is dropped into a still pond, ripples may form and spread out across the surface of the water. Similarly, the transmitter 108 may be thought of as the stone, and the SEWs may be akin to the ripples that spread along the conductive medium 102. Just as the ripples may move outward from the point of impact, SEWs may propagate along the interface 106, carrying energy with them.

The system 100 may further include a receiver 112, which may be positioned at a distance from the transmitter 108 along the interface 106. The receiver 112 may be positioned within the conductive medium 102 or within the dielectric medium 104. The receiver 112 may be configured to receive the SEWs after they have propagated along the interface 106. This may be analogous to placing one's hand in the water at a distance from where the stone was dropped, feeling the ripples as they pass by.

Additionally, the system 100 may include an object 114 positioned within the conductive medium 102 or within the dielectric medium 104, which may be representative of an obstacle that SEWs may encounter during propagation. The interaction of SEWs with the object 114 may lead to scattering of waves, similar to how water ripples may change direction or form patterns when they encounter a leaf or a rock in the pond.

The system 100 may include an energy source 116, such as a radio frequency generator, which may be connected to the transmitter 108. The energy source 116 may provide the necessary power for the transmitter 108 to generate the electromagnetic fields that excite the SEWs. This may be thought of as the force with which the stone is thrown into the pond, affecting the size and strength of the resulting ripples.

In some implementations, the system 100 may include a control unit 118, which may be operatively coupled to the transmitter 108 and/or the receiver 112. The control unit 118 may be responsible for coordinating the generation and detection of SEWs, much like a person orchestrating the timing of stones being dropped into the pond to create a specific pattern of ripples.

From a more technical perspective, SEWs may be understood as a type of wave that propagates along the interface between two media with different dielectric properties. In FIG. 1, the conductive medium 102 and the dielectric medium 104 may form such an interface (e.g., interface 106) where SEWs may be excited and propagate. The transmitter 108 may serve as a transducer that converts electrical signals from the energy source 116 into electromagnetic fields, which may then couple to the interface 106 and give rise to SEWs.

The propagation of SEWs along the interface 106 may be characterized by a wave vector that is parallel to the interface 106. This wave vector may be larger than the wave vector of free photons in the dielectric medium 104, which may result in a confinement of the electromagnetic field to the vicinity of the interface 106. The SEW's field strength may decay exponentially in the direction perpendicular to the interface 106, as illustrated by a field strength 120 extending into the dielectric medium 104 and the conductive medium 102. These field strengths may also decay as the SEW propagates along the interface 106, as illustrated by an attenuated field strength 122. The receiver 112 may be designed to couple to these confined, attenuated fields and receive the SEWs after they have propagated along the interface 106.

The excitation of SEWs by the transmitter 108 may involve the conversion of the electromagnetic energy into a surface-bound mode, which may be facilitated by the specific design of the transmitter 108. The transmitter 108 may be optimized to match the impedance of the SEWs to maximize energy transfer into the surface wave mode. The object 114 submerged within the conductive medium 102 may introduce perturbations in the SEWs, which may be detected by the receiver 112 and analyzed by the control unit 118 to infer properties of the object 114. Examples of such properties may include one or more of size, shape, location, material properties, and/or other properties.

The mathematical description of SEWs may be derived from Maxwell's equations, which govern the properties of electromagnetic fields. The wave equation for TM-polarized SEWs may be reduced to a one-dimensional Schrödinger equation:

$$\frac{{d}^{2} ψ}{{dz}^{2}} + ( {k}^{2} - V ( z ) ) ψ = 0 \qquad ( EQN . 1 )$$

where ψ is the effective wave function introduced as E_{z}=ψ/\sqrt{∈}, and V(z) is the effective potential energy that guides the propagation of SEWs along the interface. The term k² may represent the total energy of the SEWs and the term ∈ may represent the dielectric permittivity of the medium.

For TE-polarized SEWs, the wave equation may not depend on the gradient term V(z) and may be expressed as:

$$\frac{{d}^{2} {E}_{z}}{{dz}^{2}} + {k}^{2} {E}_{z} = 0 \qquad ( EQN . 2 )$$

In the case of a sharp interface between two media with dielectric permittivities ∈₁ and ∈₂, the SEW wave vector for TM-polarized waves may be given by:

$${k}_{SEW} = \sqrt{\frac{{ω}^{2}}{{c}^{2}} \frac{{ϵ}_{1} {ϵ}_{2}}{{ϵ}_{1} + {ϵ}_{2}}} \qquad ( EQN . 3 )$$

where ω is the angular frequency of the SEWs, and c is the speed of light in vacuum.

The presence of dielectric permittivity gradients across the interface 106 may lead to additional terms in the effective potential V_{z}, which may result in the formation of a potential well that supports bound states of SEWs. These bound states may correspond to surface modes with long propagation lengths and may be excited by the transmitter 108 with appropriate impedance matching.

The system 100 may thus utilize SEWs for various applications, including communication and sensing, by exploiting the unique properties of SEWs at the interface 106 between the conductive medium 102 and the dielectric medium 104. The control unit 118 may process the received signals to extract information about the propagation and interaction of SEWs with the environment and objects within it.

In some implementations, the transmitter 108 and/or the receiver 112 may include one or more plasmonic antennas. A given plasmonic antenna may be the same as or similar to, or include one or more aspects of, the antennas disclosed in U.S. patent application Ser. No. 17/570,968 entitled “Apparatus, Methods and Systems for Electromagnetic Signal Transmission Through a Conductive Medium” filed on Jan. 7, 2022; International Application No. PCT/US2024/061379 entitled “Surface Electromagnetic Wave Antenna” filed on Dec. 20, 2024; International Patent Application No. PCT/US2025/015358 entitled “Hybrid Antenna With Dynamic Signal Routing For Free-Space And Near-Metal Environments” filed on Feb. 11, 2025; International Patent Application No. PCT/US2025/020593 entitled “Detection Of Objects Behind Metal Barriers Using Plasmonic Antennas” filed on Mar. 19, 2025; and U.S. Pat. No. 12,267,114 entitled “Apparatus, Methods And Systems For Surface Electromagnetic Wave (SEW)-Based Underwater And Underground Communication And Imaging” filed on Jan. 7, 2022; of which the entirety is incorporated by reference for all purposes.

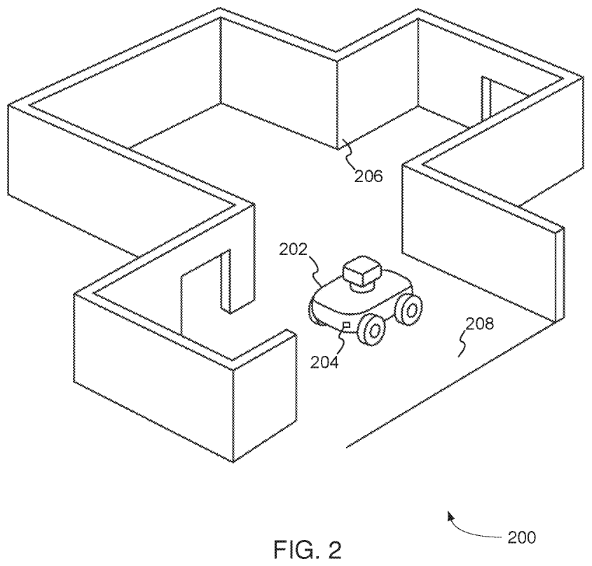

FIG. 2 shows a robotic vehicle environment 200 which supports techniques for integration of plasmonic antennas with robotic vehicles for communication and sensing in accordance with various aspects of the present disclosure. As depicted in FIG. 2, the robotic vehicle environment 200 may include one or more of a robotic vehicle 202, a plasmonic antenna 204, walls 206, floor 208, and/or other components.

The robotic vehicle 202 may include structural features that support the integration of plasmonic antennas for communication and sensing. The robotic vehicle 202 may be designed to operate in environments with physical obstructions or electromagnetic interference. The structural features of the robotic vehicle 202 may include mounting points or surfaces that accommodate the placement of plasmonic antennas. The robotic vehicle 202 may interact with other components, such as communication modules or sensors, to perform tasks in challenging environments. In some implementations, the robotic vehicle 202 may include alternative designs, such as wheeled, tracked, or legged configurations, to adapt to specific operational needs.

The plasmonic antenna 204 may represent a flexible substrate designed to conform to the contours of the robotic vehicle 202. The plasmonic antenna 204 may include conductive materials, such as copper foil, arranged on a flexible substrate to enable surface electromagnetic wave propagation. The plasmonic antenna 204 may transmit and receive signals along conductive surfaces, allowing communication in non-line-of-sight scenarios. The plasmonic antenna 204 may be connected to the robotic vehicle 202 through mounting structures and/or adhesives that ensure proper alignment and functionality. In some implementations, the plasmonic antenna 204 may be fabricated in various shapes or sizes to suit different robotic vehicle designs or operational frequencies.

The walls 206 and floor 208 may provide surfaces that interact with electromagnetic signals transmitted by the plasmonic antenna 204. The walls 206 and floor 208 may include conductive or semi-conductive materials that support the propagation of surface electromagnetic waves. The walls 206 and floor 208 may influence the behavior of the signals, such as their direction or intensity, based on their material properties. The walls 206 and floor 208 may interact with the plasmonic antenna 204 to enable communication or sensing tasks in environments with physical barriers.

In some implementations, the robotic vehicle 202 may be equipped with a plasmonic antenna 204 mounted on its structure to facilitate communication and sensing tasks. The plasmonic antenna 204 may be designed to utilize surface electromagnetic wave (SEW) propagation, allowing signals to travel along conductive surfaces such as walls 206 and floor 208. The walls 206 may present physical obstructions and metal barriers that conventional communication methods struggle to overcome. The robotic vehicle 202 may navigate through these challenging environments while maintaining communication with external operators via the plasmonic antenna 204. The plasmonic antenna 204 may be fabricated on a flexible substrate, enabling it to conform to the contours of the robotic vehicle 202 and maintain functionality despite the irregular surfaces. The robotic vehicle 202 may include RF transceivers that transmit and receive signals through the plasmonic antenna 204, leveraging SEW propagation to establish communication around corners and through metal barriers.

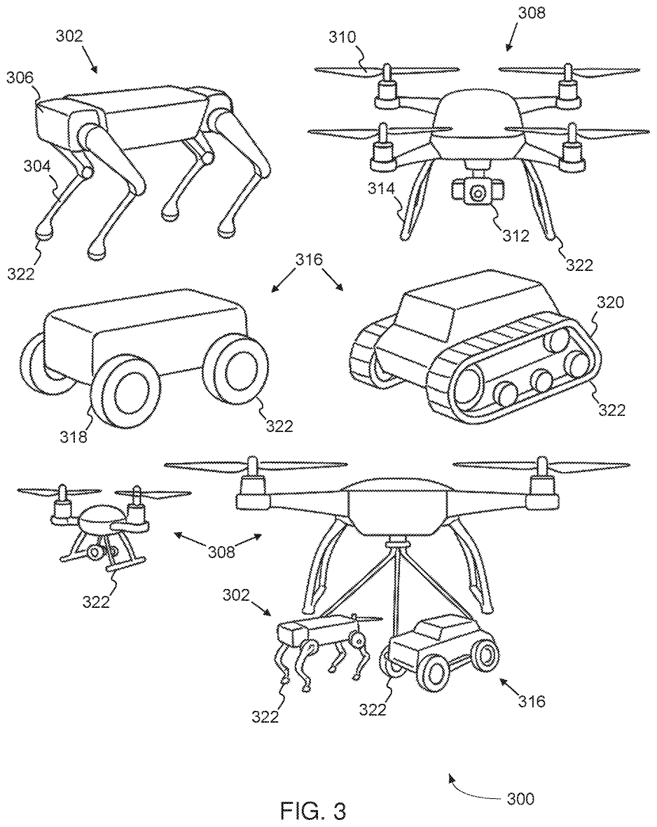

FIG. 3 shows robotic vehicles 300 which supports techniques for integration of plasmonic antennas with robotic vehicles for communication and sensing in accordance with various aspects of the present disclosure. As depicted in FIG. 3, the robotic vehicles 300 may include one or more of a robotic dog 302, robotic dog legs 304, robotic dog nose 306, an unmanned aerial vehicle (UAV) 308, UAV rotors 310, UAV camera 312, UAV landing gear 314, an unmanned ground vehicle (UGV) 316, UGV wheels 318, UGV tracks 320, plasmonic antennas 322, and/or other components.

The robotic dog 302 may include features designed to interact with various surfaces for communication and sensing tasks. The robotic dog 302 may include structural elements that may support the integration of plasmonic antennas 322 for specialized signal propagation. The robotic dog 302 may include onboard systems that may manage communication modules and sensors for detecting objects or materials. In some implementations, the robotic dog 302 may include alternative designs, such as compact robotic platforms or modular configurations, to adapt to specific operational requirements.

The robotic dog legs 304 may represent structural components capable of supporting integrated plasmonic antennas for surface-based signal propagation. The robotic dog legs 304 may include flexible mounting points that may allow plasmonic antennas 322 to conform to the contours of the legs. The robotic dog legs 304 may include conductive materials that may interact with surface electromagnetic waves for communication tasks. In some implementations, the robotic dog legs 304 may include additional features, such as embedded sensors or protective coatings, to support operations in challenging environments.

The robotic dog nose 306 may provide a mounting location for plasmonic antennas to establish contact with conductive surfaces. The robotic dog nose 306 may include a specialized interface that may allow plasmonic antennas 322 to initiate communication or sensing tasks upon contact with surfaces. The robotic dog nose 306 may include structural reinforcements that may support the integration of antennas and sensors for precise operations. In some implementations, the robotic dog nose 306 may include alternative configurations, such as retractable mechanisms or interchangeable modules, to adapt to specific tasks.

The UAV 308 may include structural elements suitable for integrating plasmonic antennas to support communication and sensing operations. The UAV 308 may include mounting points that may accommodate plasmonic antennas 322 for signal propagation along conductive surfaces. The UAV 308 may include onboard systems that may manage communication modules and sensors for detecting objects or materials. In some implementations, the UAV 308 may include alternative designs, such as compact aerial platforms or modular configurations, to adapt to specific operational requirements.

The UAV rotors 310 may represent components that facilitate aerial mobility and positioning for communication tasks. The UAV rotors 310 may include structural elements that may support the integration of plasmonic antennas 322 for specialized signal propagation. The UAV rotors 310 may include conductive materials that may interact with surface electromagnetic waves for communication tasks. In some implementations, the UAV rotors 310 may include additional features, such as embedded sensors or protective coatings, to support operations in challenging environments.

The UAV camera 312 may include imaging capabilities to support sensing applications in challenging environments. The UAV camera 312 may include specialized lenses that may capture high-resolution images for detecting objects or materials. The UAV camera 312 may include onboard systems that may process captured images for analysis and classification tasks. In some implementations, the UAV camera 312 may include alternative configurations, such as thermal imaging modules or night vision capabilities, to adapt to specific operational requirements.

The UAV landing gear 314 may provide structural support for plasmonic antenna integration during ground-based operations. The UAV landing gear 314 may include flexible mounting points that may allow plasmonic antennas 322 to conform to the contours of the gear. The UAV landing gear 314 may include conductive materials that may interact with surface electromagnetic waves for communication tasks. In some implementations, the UAV landing gear 314 may include additional features, such as embedded sensors or protective coatings, to support operations in challenging environments.

The UGV 316 may include a platform capable of integrating plasmonic antennas for ground-based communication and sensing. The UGV 316 may include mounting points that may accommodate plasmonic antennas 322 for signal propagation along conductive surfaces. The UGV 316 may include onboard systems that may manage communication modules and sensors for detecting objects or materials. In some implementations, the UGV 316 may include alternative designs, such as compact ground platforms or modular configurations, to adapt to specific operational requirements.

The UGV wheels 318 may represent components that may include plasmonic antennas for signal propagation through conductive surfaces. The UGV wheels 318 may include flexible mounting points that may allow plasmonic antennas 322 to conform to the contours of the wheels. The UGV wheels 318 may include conductive materials that may interact with surface electromagnetic waves for communication tasks. In some implementations, the UGV wheels 318 may include additional features, such as embedded sensors or protective coatings, to support operations in challenging environments.

The UGV tracks 320 may provide additional surface contact points that may support plasmonic antenna integration for communication tasks. The UGV tracks 320 may include flexible mounting points that may allow plasmonic antennas 322 to conform to the contours of the tracks. The UGV tracks 320 may include conductive materials that may interact with surface electromagnetic waves for communication tasks. In some implementations, the UGV tracks 320 may include additional features, such as embedded sensors or protective coatings, to support operations in challenging environments.

The plasmonic antennas 322 may include flexible substrates designed to conform to various robotic vehicle structures for communication and sensing. In some implementations, the plasmonic antennas 322 may be the same as or similar to the plasmonic antenna 204, as described herein.

In some implementations, the robotic dog 302 may include plasmonic antennas 322 integrated into its legs 304 and nose 306, where the antennas 322 may conform to the contours of these components to maintain functionality during movement or contact with surfaces. The UAV 308 may feature plasmonic antennas 322 mounted on its landing gear 314 and structural arms near the rotors 310, which may allow the antennas 322 to interact with conductive surfaces during flight or landing. The UAV camera 312 may operate in conjunction with the plasmonic antennas 322 to determine environmental characteristics based on received signals.

In some implementations, the UGV 316 may incorporate plasmonic antennas 322 into its wheels 318 and tracks 320, where the antennas 322 may establish communication or sensing through the ground as the UGV 316 moves. The robotic dog 302, UAV 308, and UGV 316 may operate collaboratively, with the plasmonic antennas 322 on each vehicle interacting with conductive surfaces or transmitting signals to other vehicles. The arrangement of plasmonic antennas 322 across these components may allow the robotic vehicles to determine material properties or detect objects in their surroundings.

According to some implementations, the use of multiple plasmonic antennas on the robotic vehicles 300 may facilitate directional signal transmission, allowing the robotic vehicles 300 to focus communication power in specific directions for improved range and reliability.

In some implementations, hybrid antenna configurations combining plasmonic and conventional antennas may be integrated into the robotic dog 302, UAV 308, and UGV 316. These hybrid systems may dynamically switch between plasmonic and conventional antennas based on environmental conditions, ensuring optimal signal propagation and reliability. For instance, the robotic dog 302 may feature hybrid antennas embedded in its legs 304 and nose 306, allowing seamless transitions between conventional antenna operation in free-space environments and plasmonic antenna operation near conductive surfaces or in scenarios where conventional signals are blocked. This dual-mode capability may enable the robotic dog 302 to maintain robust communication and sensing performance in diverse operational settings.

The UAV 308 may incorporate hybrid antennas strategically positioned on its rotors 310, landing gear 314, and structural arms. These hybrid antennas may operate in tandem, leveraging the strengths of both plasmonic and conventional technologies to optimize signal transmission during flight, landing, or proximity to metallic surfaces. In some implementations, conformal plasmonic antennas may be wrapped around the UAV 308, providing multi-directional coupling and enhancing signal propagation regardless of the UAV's orientation. Additionally, multiple plasmonic antennas may work collaboratively to direct signals with greater power and precision, enabling the UAV 308 to establish reliable communication links even in challenging environments.

The UGV 316 may include hybrid antenna systems integrated into its wheels 318 and/or tracks 320, enabling dynamic switching between conventional and plasmonic modes based on terrain and environmental conditions. For example, when operating on conductive surfaces or near metallic obstacles, the plasmonic antennas may take over to ensure uninterrupted communication and sensing. Alternatively, conventional antennas may handle signal propagation in open, non-conductive environments. This hybrid approach may allow the UGV 316 to adapt to varying operational scenarios while maintaining high-performance communication and sensing capabilities.

In some implementations, robotic vehicles 300 equipped with hybrid antenna systems may collaborate to achieve enhanced communication and sensing. For instance, the robotic dog 302, UAV 308, and UGV 316 may share data through their hybrid antennas, dynamically selecting the strongest signal path for efficient transmission. This collaborative approach may enable the vehicles to detect objects, analyze material properties, and navigate complex environments with greater accuracy.

The integration of hybrid plasmonic/conventional antennas into robotic vehicles 300 may provide a versatile and adaptive solution for communication and sensing in diverse environments. By dynamically switching between antenna modes and leveraging the strengths of both technologies, these systems may ensure optimal performance, enabling robotic vehicles to navigate, detect, and communicate effectively in challenging operational scenarios.

In some implementations, the robotic vehicles 300 may include a system of multiple plasmonic antennas strategically positioned to enable an unmanned system to locate the nearest conductive surface regardless of its orientation. For example, the robotic dog 302 may feature plasmonic antennas 322 distributed across its legs 304, nose 306, and torso, forming a network of antennas capable of detecting surface electromagnetic waves from multiple directions. This configuration may allow the robotic dog 302 to maintain communication and sensing capabilities even when navigating uneven terrain or complex environments. Similarly, the UAV 308 may include plasmonic antennas 322 mounted on its landing gear 314, rotors 310, and structural arms, enabling the UAV 308 to detect conductive surfaces during flight, hovering, or landing. The UGV 316 may incorporate plasmonic antennas 322 into its wheels 318, tracks 320, and chassis, ensuring reliable signal propagation and surface detection as the vehicle maneuvers through challenging ground conditions.

In some implementations, the robotic vehicles 300 may utilize one or more conformal plasmonic antennas that cover multiple sides of the UAV 308 to facilitate better coupling with conductive surfaces. For instance, the UAV 308 may feature conformal plasmonic antennas 322 integrated into its fuselage and rotor arms, creating a seamless antenna array that maximizes surface electromagnetic wave interaction. This design may enhance the UAV's ability to maintain communication and sensing capabilities while in flight, regardless of its orientation relative to the surface. The conformal plasmonic antennas 322 may also provide additional structural benefits, such as improved aerodynamics and reduced weight, making them ideal for compact aerial platforms.

Some implementations may involve one or more plasmonic antennas that loop around the drone, similarly enabling better coupling with conductive surfaces. For example, the UAV 308 may include a ring-shaped plasmonic antenna 322 encircling its body, ensuring consistent signal propagation and surface detection from all angles. This looped antenna design may be particularly advantageous for UAVs operating in environments with limited visibility or complex obstacles, as it allows the drone to maintain communication and sensing capabilities without requiring precise alignment with the surface. The looped plasmonic antennas 322 may also be integrated into the UAV's structural framework, providing additional durability and flexibility for various operational scenarios.

In some implementations, the robotic vehicles 300 may operate collaboratively, with the plasmonic antennas 322 on each vehicle forming a networked system for enhanced communication and sensing. For instance, the robotic dog 302, UAV 308, and UGV 316 may share data collected by their plasmonic antennas 322 to create a comprehensive map of the environment, identifying conductive surfaces, material properties, and potential obstacles. This collaborative approach may enable the robotic vehicles to perform complex tasks, such as search and rescue operations, environmental monitoring, or infrastructure inspection, with greater efficiency and accuracy. The integration of multiple plasmonic antennas 322 across the robotic vehicles 300 may provide a robust solution for navigating and interacting with conductive surfaces in diverse and challenging environments.

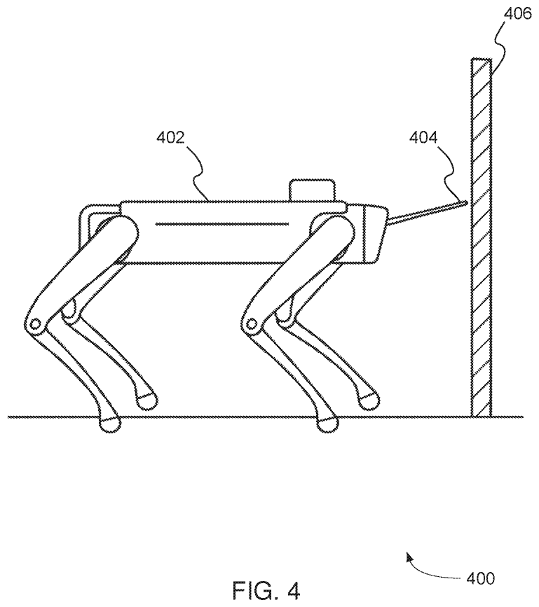

FIG. 4 shows a robotic dog environment 400 which supports techniques for integration of plasmonic antennas with robotic vehicles for communication and sensing in accordance with various aspects of the present disclosure. As depicted in FIG. 4, the robotic dog environment 400 may include one or more of a robotic dog 402, a plasmonic antenna 404, a metal barrier 406, and/or other components.

The robotic dog 402 may include structural features that support the integration of plasmonic antennas for communication and sensing. In some implementations, the robotic dog 402 may be the same as or similar to the robotic dog 302, as described herein.

The plasmonic antenna 404 is positioned on a structure protruding from various robotic vehicles for communication and sensing. In some implementations, the plasmonic antenna 404 may be the same as or similar to the plasmonic antenna 204 and the plasmonic antennas 322, as described herein.

The metal barrier 406 may represent a physical obstruction that interacts with plasmonic antenna signals during communication and sensing operations. In some implementations, the metal barrier 406 may be the same as or similar to the walls 206, as described herein.

In some implementations, the robotic dog 402 may include the plasmonic antenna 404 mounted on its nose, which may extend outward to make contact with the metal barrier 406. The metal barrier 406 may consist of a conductive material that may support surface electromagnetic wave propagation when the plasmonic antenna 404 interacts with its surface. The robotic dog 402 may position itself such that the plasmonic antenna is positioned at or near the metal barrier 406, allowing signals to travel along the conductive surface of the metal barrier 406.

In some implementations, the robotic dog 402 may incorporate onboard sensors that may detect variations in the dielectric properties of the metal barrier 406. These sensors may work in conjunction with the plasmonic antenna 404 to determine material characteristics or detect objects located behind the metal barrier 406. The robotic dog 402 may transmit signals through the plasmonic antenna 404 while receiving reflected or transmitted signals from the metal barrier 406, which may be processed by onboard signal processing units to extract relevant environmental data.

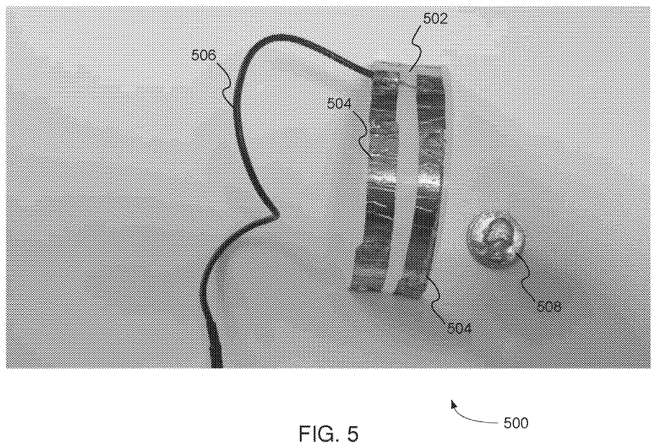

FIG. 5 shows flexible plasmonic antenna 500 which supports techniques for integration of plasmonic antennas with robotic vehicles for communication and sensing in accordance with various aspects of the present disclosure. As depicted in FIG. 5, the flexible plasmonic antenna 500 may include one or more of a flexible substrate 502, copper strips 504, a coaxial cable 506, and/or other components. In some implementations, the flexible plasmonic antenna 500 may be the same as or similar to the plasmonic antenna 204 and/or plasmonic antennas 322, as described herein.

The flexible substrate 502 may include a design that conforms to various surfaces for integration with robotic vehicles. The flexible substrate 502 may be formed of plastic or other durable and flexible materials. The flexible substrate 502 may include an adhesive substance on one or both sides to facilitate mounting to a structure of a robotic vehicle.

The copper strips 504 may represent conductive elements that facilitate signal propagation in the flexible plasmonic antenna 500. The copper strips 504 may include a specific width and thickness to support efficient surface electromagnetic wave propagation. The copper strips 504 may be arranged in a parallel configuration to form a resonant structure for signal transmission. In some implementations, the copper strips 504 may be connected to the coaxial cable 506 to enable signal input and output. Alternative materials for the copper strips 504 may include aluminum or silver, depending on the desired conductivity and application requirements.

The coaxial cable 506 may include a connection interface for transmitting and receiving signals to and from the copper strips 504. The coaxial cable 506 may include an outer shielding layer to reduce electromagnetic interference during signal transmission. The coaxial cable 506 may be terminated with a standard RF connector to interface with communication systems. In some implementations, the coaxial cable 506 may be detachable to allow for easy replacement or reconfiguration. Other types of cables, such as twisted-pair cables, may be used as alternatives to the coaxial cable 506 in specific scenarios.

In some implementations, the flexible plasmonic antenna 500 may include copper strips 504 arranged in parallel on a surface of the flexible substrate 502, which may serve as conductive pathways for signal propagation. The copper strips 504 may be adhered to the flexible substrate 502, allowing the antenna to conform to irregular shapes while maintaining its structural integrity. A coaxial cable 506 may be connected to the copper strips 504, which may transmit signals to and from the flexible plasmonic antenna 500 for communication or sensing tasks. A quarter coin 508 may be positioned adjacent to the flexible plasmonic antenna 502 to illustrate the relative scale of the antenna and its components.

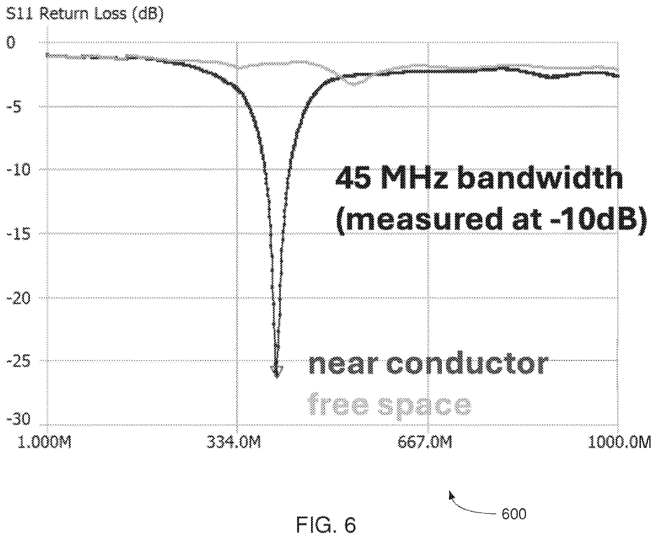

FIG. 6 shows a graph 600 illustrating the S11 return loss (dB) as a function of frequency (MHz) in accordance with various aspects of the present disclosure. The graph 600 may represent the performance characteristics of a flexible plasmonic antenna operating at 404 MHz, which may be integrated into robotic vehicles for communication and sensing tasks. The graph 600 may provide insight into the antenna's ability to maintain effective signal transmission and reception in different environments, including near conductive surfaces and in free space.

The horizontal axis of the graph 600 may represent the frequency in megahertz (MHz), ranging from approximately 1 MHz to 1000 MHz. The scale may be linear, allowing for a straightforward interpretation of frequency intervals. The vertical axis may represent the S11 return loss in decibels (dB), with values ranging from 0 dB at the top to −30 dB at the bottom. The return loss may indicate the amount of power reflected back from the antenna, with lower values suggesting better impedance matching and signal efficiency.

The data points in the graph 600 may be represented by continuous lines, with one line corresponding to measurements taken near a conductor (e.g., a metal sheet) and another line corresponding to measurements taken in free space. The graph 600 may exhibit a pronounced dip in return loss at approximately 404 MHz, where the return loss may reach a minimum value of approximately −25 dB. This dip may indicate the resonant frequency of the plasmonic antenna, where it may achieve optimal performance. The bandwidth of the antenna, measured at the −10 dB threshold, may span approximately 45 MHz, suggesting a range of frequencies over which the antenna may operate effectively.

The graph 600 may highlight the differences in performance between the antenna's operation near a conductor and in free space. The line representing measurements near a conductor may show a slightly shifted or altered response compared to the line representing free space measurements, which may be attributed to the influence of the conductive surface on the antenna's electromagnetic properties. These variations may demonstrate the antenna's adaptability to different environmental conditions.

The graph 600 may include notable features such as the sharp peak at the resonant frequency and the relatively flat regions outside the bandwidth, which may indicate reduced signal efficiency at non-resonant frequencies. The continuous lines may provide a clear visual representation of the antenna's performance across the frequency spectrum, allowing for an assessment of its suitability for specific applications.

The graph 600 may serve as a detailed representation of the plasmonic antenna's return loss characteristics, offering valuable information about its operational bandwidth, resonant frequency, and performance in varying conditions. The features depicted in the graph 600 may support the integration of such antennas into robotic vehicles for enhanced communication and sensing capabilities in complex environments.

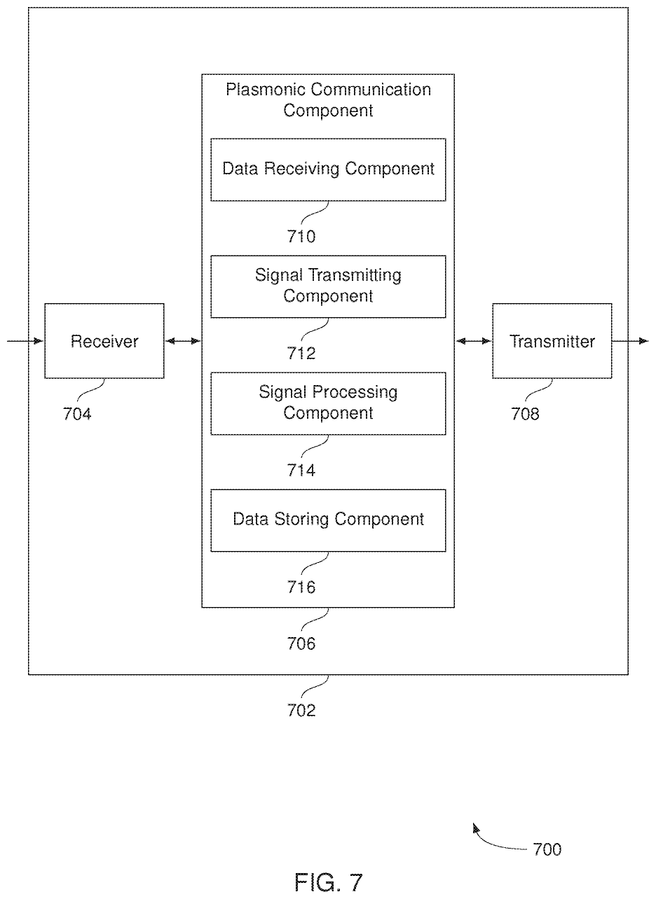

FIG. 7 shows a block diagram 700 of an apparatus 702 that supports integration of plasmonic antennas with robotic vehicles for communication and sensing in accordance with various aspects of the present disclosure. The apparatus 702 may be the same as or similar to one or more components described in connection with the environment 100 of FIG. 1. The apparatus 702 may include an input module 704, plasmonic communication component 706, and an output module 708. The apparatus 702 may also include a processor. Each of these components may be in communication with one another (e.g., via one or more buses). In some cases, the apparatus 702 may be an example of a user terminal, a database server, or a system containing multiple computing devices.

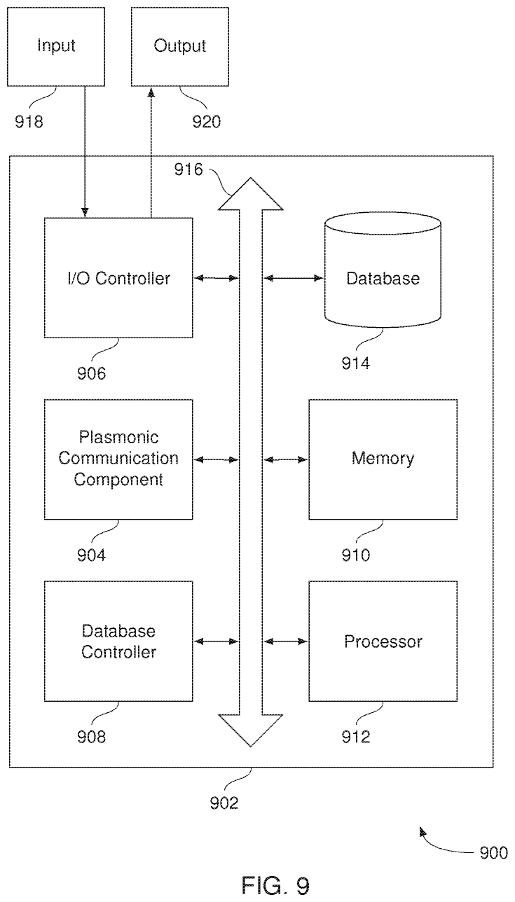

The input module 704 may manage input signals for the apparatus 702. For example, the input module 704 may identify input signals based on an interaction with a modem, a keyboard, a mouse, a touchscreen, or a similar device. These input signals may be associated with user input or processing at other components or devices. In some cases, the input module 704 may utilize an operating system such as iOS®, ANDROID®, MS-DOS®, MS-WINDOWS®, OS/2®, UNIX®, LINUX®, or another known operating system to handle input signals. The input module 704 may send aspects of these input signals to other components of the apparatus 702 for processing. In some cases, the input module 704 may be a component of an input/output (I/O) controller 906 as described with reference to FIG. 9.

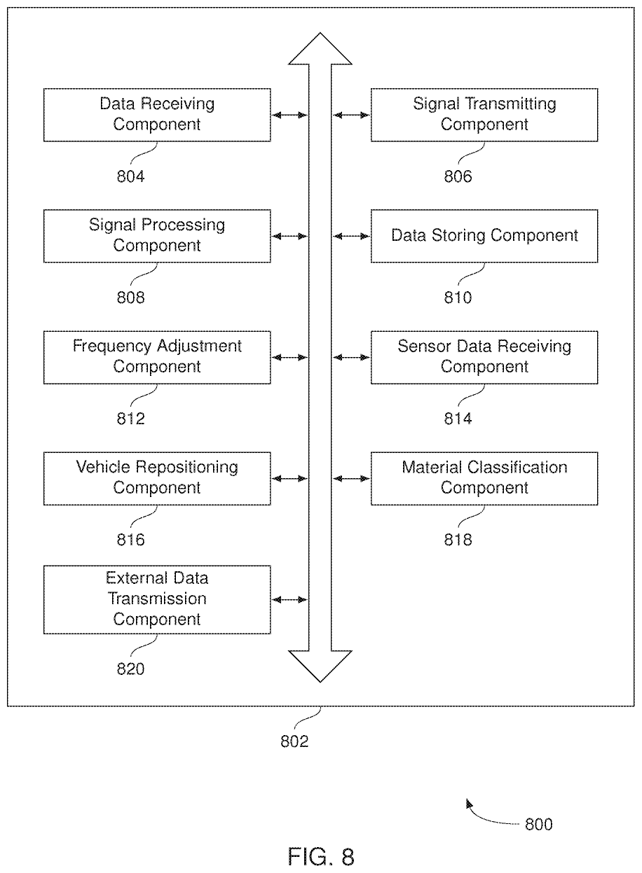

The plasmonic communication component 706 may include one or more of a data receiving component 710, a signal transmitting component 712, a signal processing component 714, a data storing component 716, and/or other components. The plasmonic communication component 706 may be an example of aspects of the plasmonic communication component 802 or 904 described with reference to FIGS. 8 and 9.

The data receiving component 710 may be configured as or otherwise support a means for receiving data indicative of a robotic vehicle's operational environment, the robotic vehicle including a plasmonic antenna mounted on a structure configured to contact a surface. The signal transmitting component 712 may be configured as or otherwise support a means for transmitting control signals to the robotic vehicle to activate the plasmonic antenna for surface electromagnetic wave propagation along the surface. The signal processing component 714 may be configured as or otherwise support a means for processing signals received from the plasmonic antenna to determine communication or sensing data associated with the operational environment. The data storing component 716 may be configured as or otherwise support a means for storing the communication or sensing data in a memory for subsequent analysis or use.

The output module 708 may manage output signals for the apparatus 702. For example, the output module 708 may receive signals from other components of the apparatus 702, such as the plasmonic communication component 706, and may transmit these signals to other components or devices. In some specific examples, the output module 708 may transmit output signals for display in a user interface, for storage in a database or data store, for further processing at a server or server cluster, or for any other processes at any number of devices or systems. In some cases, the output module 708 may be a component of an I/O controller 906 as described with reference to FIG. 9.

FIG. 8 shows a block diagram 800 of a plasmonic communication component 802 that supports integration of plasmonic antennas with robotic vehicles for communication and sensing in accordance with various aspects of the present disclosure. The plasmonic communication component 802 may be an example of aspects of a plasmonic communication component 706, a plasmonic communication component 904, or both, as described herein. The plasmonic communication component 802, or various components thereof, may be an example of means for performing various aspects of integration of plasmonic antennas with robotic vehicles for communication and sensing as described herein. For example, the plasmonic communication component 802 may include one or more of a data receiving component 804, a signal transmitting component 806, a signal processing component 808, a data storing component 810, a frequency adjustment component 812, a sensor data receiving component 814, a vehicle repositioning component 816, a material classification component 818, an external data transmission component 820, and/or other components. Each of these components may communicate, directly or indirectly, with one another (e.g., via one or more buses).

The data receiving component 804 may be configured as or otherwise support a means for receiving data indicative of a robotic vehicle's operational environment, the robotic vehicle may include a plasmonic antenna mounted on a structure that may be configured to contact a surface. The data receiving component 804 may determine signal characteristics from the plasmonic antenna that may correspond to surface properties such as conductivity or texture. The data receiving component 804 may interpret variations in received signals to identify potential obstacles or material types in the operational environment. The data receiving component 804 may process data from multiple plasmonic antennas mounted on different parts of the robotic vehicle to create a composite representation of the environment.

The plasmonic antenna mounted on a structure may include flexible substrates that may conform to irregular surfaces to maintain contact during movement. The plasmonic antenna mounted on a structure may be positioned on the robotic vehicle's legs or feet to interact with conductive surfaces during locomotion. The plasmonic antenna mounted on a structure may be integrated into movable arms that may adjust positioning to establish contact with specific surfaces for communication or sensing tasks. The plasmonic antenna mounted on a structure may include configurations that may operate across a range of frequencies to adapt to varying environmental conditions.

The signal transmitting component 806 may be configured as or otherwise support a means for transmitting control signals to the robotic vehicle to activate the plasmonic antenna for surface electromagnetic wave propagation along the surface. In some implementations, the signal transmitting component 806 may send signals to adjust the frequency of the plasmonic antenna to match the surface properties. The signal transmitting component 806 may include a module that may determine the optimal timing for signal transmission based on the robotic vehicle's movement. The signal transmitting component 806 may be capable of transmitting signals that may initiate communication protocols specific to the operational environment.

The signal processing component 808 may be configured as or otherwise support a means for processing signals received from the plasmonic antenna to determine communication or sensing data associated with the operational environment. In some implementations, the signal processing component 808 may analyze variations in signal amplitude to identify surface irregularities or conductive properties. The signal processing component 808 may interpret frequency shifts in the received signals to infer material characteristics or environmental changes. In some implementations, the signal processing component 808 may process phase information from the signals to determine spatial relationships or distances to objects in the operational environment.

The data storing component 810 may be configured as or otherwise support a means for storing the communication or sensing data in a memory for subsequent analysis or use. In some implementations, the memory may include a high-capacity storage device capable of retaining data from multiple robotic vehicles operating simultaneously. In some implementations, the memory may be distributed across several modules to accommodate data from diverse sensing tasks performed by the robotic vehicles. In some implementations, the memory may support encryption protocols to secure the stored data against unauthorized access.

In some examples, the frequency adjustment component 812 may be configured as or otherwise support a means for transmitting control signals to adjust a frequency of the plasmonic antenna based on the data indicative of the operational environment to facilitate surface electromagnetic wave propagation across varying material properties of the surface. In some implementations, the frequency adjustment component 812 may determine the specific frequency range required for communication over a metal barrier by analyzing the conductivity of the surface. In some implementations, the frequency adjustment component 812 may transmit control signals to fine-tune the plasmonic antenna's frequency to match the dielectric properties of a surface encountered by a robotic vehicle. In some implementations, the frequency adjustment component 812 may adjust the frequency to accommodate transitions between different surface types, such as moving from a metallic surface to a non-conductive surface.

In some examples, the sensor data receiving component 814 may be configured as or otherwise support a means for receiving additional data from onboard sensors of the robotic vehicle that may be indicative of dielectric properties of objects in the operational environment and may be correlating the additional data with the signals received from the plasmonic antenna. In some implementations, the sensor data receiving component 814 may receive data from sensors that may detect variations in material composition, such as distinguishing between metallic and non-metallic surfaces. In some implementations, the sensor data receiving component 814 may process data from sensors that may measure changes in electromagnetic wave absorption to infer the presence of specific materials. In some implementations, the sensor data receiving component 814 may interpret data from sensors that may detect shifts in surface conductivity to identify transitions between different types of objects.

In some examples, the vehicle repositioning component 816 may be configured as or otherwise support a means for transmitting control signals to reposition the robotic vehicle to establish contact between the plasmonic antenna and a different surface in response to detecting a change in the operational environment. In some implementations, the vehicle repositioning component 816 may determine the optimal angle for the plasmonic antenna to maintain effective communication. The vehicle repositioning component 816 may adjust the robotic vehicle's position to ensure the plasmonic antenna remains in contact with conductive surfaces during movement. In some implementations, the vehicle repositioning component 816 may transmit signals to the robotic vehicle's locomotion system to navigate around obstacles and maintain contact with the desired surface. The vehicle repositioning component 816 may include sensors that detect variations in surface properties to guide the repositioning process. In some implementations, the vehicle repositioning component 816 may store data on previous surface interactions to inform future repositioning decisions.

In some examples, the material classification component 818 may be configured as or otherwise support a means for processing the signals received from the plasmonic antenna to classify materials in the operational environment based on their electromagnetic response characteristics. In some implementations, the material classification component 818 may determine variations in signal amplitude to identify differences in surface conductivity among materials. In some implementations, the material classification component 818 may interpret phase shifts in the received signals to distinguish between metallic and non-metallic surfaces. In some implementations, the material classification component 818 may analyze frequency-dependent signal attenuation to infer the dielectric properties of encountered materials.

In some implementations, the material classification component 818 may process data from multiple plasmonic antennas to compare electromagnetic responses across different locations in the operational environment. In some implementations, the material classification component 818 may determine the presence of composite materials by identifying unique combinations of electromagnetic response characteristics. In some implementations, the material classification component 818 may correlate signal variations with known material profiles stored in a database to classify encountered objects.

In some examples, the external data transmission component 820 may be configured as or otherwise support a means for transmitting the communication or sensing data to an external system for real-time monitoring or coordination of multiple robotic vehicles in the operational environment. In some implementations, the external data transmission component 820 may transmit data to a centralized control station that may analyze the operational environment and relay instructions to robotic vehicles. In some implementations, the external data transmission component 820 may send data to a distributed network of external systems that may process information independently to support localized decision-making. In some implementations, the external data transmission component 820 may transmit data to external systems equipped with visualization tools that may display environmental maps generated from the sensing data.

FIG. 9 shows a diagram of a system 900 including a device 902 that supports integration of plasmonic antennas with robotic vehicles for communication and sensing in accordance with aspects of the present disclosure. The device 902 may be an example of or include the components of a database server or an apparatus 702 as described herein. The device 902 may include components for bi-directional data communications including components for transmitting and receiving communications, including a plasmonic communication component 904, an I/O controller 906, a database controller 908, memory 910, a processor 912, and a database 914. These components may be in electronic communication via one or more buses (e.g., bus 916).

The plasmonic communication component 904 may be an example of a plasmonic communication component 706 or 802 as described herein. For example, the plasmonic communication component 904 may perform any of the methods or processes described above with reference to FIGS. 7 and 8. In some cases, the plasmonic communication component 904 may be implemented in hardware, software executed by a processor, firmware, or any combination thereof.

The I/O controller 906 may manage input signals 918 and output signals 920 for the device 902. The I/O controller 906 may also manage peripherals not integrated into the device 902. In some cases, the I/O controller 906 may represent a physical connection or port to an external peripheral. In some cases, the I/O controller 906 may utilize an operating system such as iOS®, ANDROID®, MS-DOS®, MS-WINDOWS®, OS/2®, UNIX®, LINUX®, or another known operating system. In other cases, the I/O controller 906 may represent or interact with a modem, a keyboard, a mouse, a touchscreen, or a similar device. In some cases, the I/O controller 906 may be implemented as part of a processor. In some cases, a user may interact with the device 902 via the I/O controller 906 or via hardware components controlled by the I/O controller 906.

The database controller 908 may manage data storage and processing in a database 914. In some cases, a user may interact with the database controller 908. In other cases, the database controller 908 may operate automatically without user interaction. The database 914 may be an example of a single database, a distributed database, multiple distributed databases, a data store, a data lake, or an emergency backup database.

Memory 910 may include random-access memory (RAM) and read-only memory (ROM). The memory 910 may store computer-readable, computer-executable software including instructions that, when executed, cause the processor to perform various functions described herein. In some cases, the memory 910 may contain, among other things, a basic input/output system (BIOS) which may control basic hardware or software operation such as the interaction with peripheral components or devices.

The processor 912 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 912 may be configured to operate a memory array using a memory controller. In other cases, a memory controller may be integrated into the processor 912. The processor 912 may be configured to execute computer-readable instructions stored in a memory 910 to perform various functions (e.g., functions or tasks supporting integration of plasmonic antennas with robotic vehicles for communication and sensing).

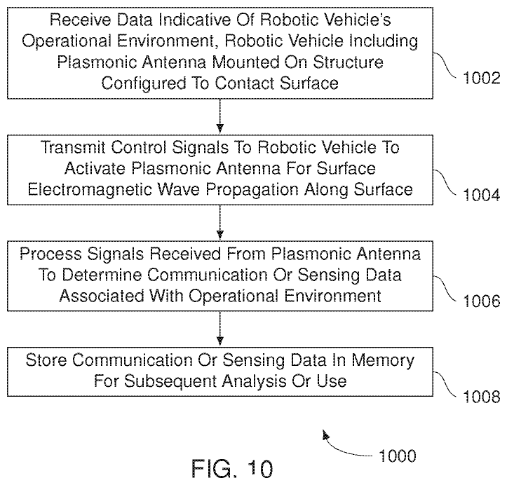

FIG. 10 shows a flowchart illustrating a method 1000 that supports integration of plasmonic antennas with robotic vehicles for communication and sensing in accordance with various aspects of the present disclosure. The operations of the methods described herein may be implemented by one or more of a device, an apparatus, a system (e.g., a networked computing system), and/or components thereof as described herein. For example, the operations of the method 1000 may be performed by a plasmonic communication component as described with reference to FIGS. 7 through 9. In some examples, one or more components of a device, apparatus, and/or system may execute a set of instructions to control the functional elements of the component(s) to perform the described functions. Additionally or alternatively, the one or more components of a device, apparatus, and/or system may perform aspects of the described functions using special-purpose hardware.

At 1002, the method 1000 may include receiving data indicative of a robotic vehicle's operational environment, the robotic vehicle including a plasmonic antenna mounted on a structure configured to contact a surface. The operations of 1002 may be performed in accordance with examples as disclosed herein. In some examples, aspects of the operations of 1002 may be performed by a data receiving component 804 as described with reference to FIG. 8.

At 1004, the method 1000 may include transmitting control signals to the robotic vehicle to activate the plasmonic antenna for surface electromagnetic wave propagation along the surface. The operations of 1004 may be performed in accordance with examples as disclosed herein. In some examples, aspects of the operations of 1004 may be performed by a signal transmitting component 806 as described with reference to FIG. 8.

At 1006, the method 1000 may include processing signals received from the plasmonic antenna to determine communication or sensing data associated with the operational environment. The operations of 1006 may be performed in accordance with examples as disclosed herein. In some examples, aspects of the operations of 1006 may be performed by a signal processing component 808 as described with reference to FIG. 8.

At 1008, the method 1000 may include storing the communication or sensing data in a memory for subsequent analysis or use. The operations of 1008 may be performed in accordance with examples as disclosed herein. In some examples, aspects of the operations of 1008 may be performed by a data storing component 810 as described with reference to FIG. 8.

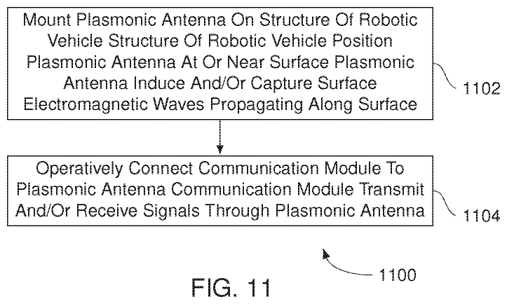

FIG. 11 shows a flowchart illustrating a method 1100 involving plasmonic communication systems in accordance with various aspects of the present disclosure.

At 1102, the method 1100 may include mounting a plasmonic antenna on a structure of a robotic vehicle, the structure of the robotic vehicle positioning the plasmonic antenna at or near a surface, the plasmonic antenna inducing and/or capturing surface electromagnetic waves propagating along the surface. The operations of 1102 may be performed in accordance with examples as disclosed herein. In some examples, aspects of the operations of 1102 may involve a plasmonic antenna 204, a robotic vehicle 202, walls 206, a flexible plasmonic antenna 502, copper strips 504, a coaxial cable 506, and/or a quarter coin 508 as described with reference to FIGS. 2 and 5.

At 1104, the method 1100 may include operatively connecting a communication module to the plasmonic antenna, the communication module transmitting and/or receiving signals through the plasmonic antenna. The operations of 1104 may be performed in accordance with examples as disclosed herein. In some examples, aspects of the operations of 1104 may involve communication systems 102, navigation systems 112, surveillance devices 104, transportation apparatuses 106, energy resources 108, protective equipment 110, and/or plasmonic antennas 322 as described with reference to FIGS. 1 and 3.

It should be noted that the methods presented herein describe possible implementations, and that the operations and the steps may be rearranged or otherwise modified and that other implementations are possible. Furthermore, aspects from two or more of the methods may be combined.

Aspect 1: A system for plasmonic communications and sensing with robotic vehicles, comprising: a plasmonic antenna configured to be mounted on a structure of a robotic vehicle, the structure of the robotic vehicle configured to position the plasmonic antenna at or near a surface, the plasmonic antenna configured to induce and/or capture surface electromagnetic waves propagating along the surface; and a communication module operatively connected to the plasmonic antenna, the communication module configured to transmit and/or receive signals through the plasmonic antenna.

Aspect 2: The system of aspect 1, wherein the plasmonic antenna is fabricated on a flexible substrate, the flexible substrate configured to conform to a contour of the structure of the robotic vehicle.

Aspect 3: The system of any of aspects 1 through 2, wherein the plasmonic antenna includes copper strips, the copper strips configured to enhance the induction and/or capture of surface electromagnetic waves propagating along the surface.

Aspect 4: The system of any of aspects 1 through 3, further comprising a coaxial cable operatively connected to the communication module, the coaxial cable configured to transmit signals between the communication module and the plasmonic antenna.

Aspect 5: The system of any of aspects 1 through 4, wherein the structure of the robotic vehicle is configured to position the plasmonic antenna near conducting surfaces, the conductor surfaces configured to support the propagation of surface electromagnetic waves.

Aspect 6: The system of any of aspects 1 through 5, further comprising a tuning mechanism operatively connected to the plasmonic antenna, the tuning mechanism configured to adjust the operational frequency of the plasmonic antenna.

Aspect 7: The system of any of aspects 1 through 6, wherein the structure of the robotic vehicle includes a mounting location near conducting surfaces, the mounting location configured to position the plasmonic antenna to induce surface electromagnetic waves along the conductor surfaces.

Aspect 8: The system of any of aspects 1 through 7, wherein the plasmonic antenna is a flexible 433 MHz plasmonic antenna configured to operate with multiple radio systems to facilitate communication in environments with significant electromagnetic interference.

Aspect 9: The system of any of aspects 1 through 8, wherein the communication module is configured to analyze signals received by the plasmonic antenna to detect objects based on their dielectric properties.

Aspect 10: The system of any of aspects 1 through 9, wherein the plasmonic antenna is configured to transfer signals along a surface in response to the robotic vehicle encountering a non-line-of-sight scenario.

Aspect 11: The system of any of aspects 1 through 10, wherein the plasmonic antenna is configured to establish communication over a metal barrier in response to the robotic vehicle being positioned near the metal barrier.

Aspect 12: The system of any of aspects 1 through 11, wherein the plasmonic antenna operates in conjunction with one or more other plasmonic antennas to perform sensing tasks by inducing and/or receiving surface electromagnetic waves along a conductive surface to classify materials based on their dielectric properties.

Aspect 13: The system of any of aspects 1 through 12, wherein the plasmonic antenna is configured to be mounted near conducting surfaces to enable communication and sensing tasks in environments with significant free space signal attenuation.

Aspect 14: A method for plasmonic communications and sensing with robotic vehicles, comprising: mounting a plasmonic antenna on a structure of a robotic vehicle, the structure of the robotic vehicle positioning the plasmonic antenna at or near a surface, the plasmonic antenna inducing and/or capturing surface electromagnetic waves propagating along the surface; and operatively connecting a communication module to the plasmonic antenna, the communication module transmitting and/or receiving signals through the plasmonic antenna.

Aspect 15: A method for using plasmonic antennas integrated with robotic vehicles for communication and sensing, comprising: receiving data indicative of a robotic vehicle's operational environment, the robotic vehicle including a plasmonic antenna mounted on a structure configured to contact a surface; transmitting control signals to the robotic vehicle to activate the plasmonic antenna for surface electromagnetic wave propagation along the surface; processing signals received from the plasmonic antenna to determine communication or sensing data associated with the operational environment; and storing the communication or sensing data in a memory for subsequent analysis or use.

Aspect 16: The method of aspect 15, further comprising transmitting control signals to adjust a frequency of the plasmonic antenna based on the data indicative of the operational environment to facilitate surface electromagnetic wave propagation across varying material properties of the surface.

Aspect 17: The method of any of aspects 15 through 16, further comprising receiving additional data from onboard sensors of the robotic vehicle indicative of dielectric properties of objects in the operational environment and correlating the additional data with the signals received from the plasmonic antenna.

Aspect 18: The method of any of aspects 15 through 17, further comprising transmitting control signals to reposition the robotic vehicle to establish contact between the plasmonic antenna and a different surface in response to detecting a change in the operational environment.

Aspect 19: The method of any of aspects 15 through 18, further comprising processing the signals received from the plasmonic antenna to classify materials in the operational environment based on their electromagnetic response characteristics.

Aspect 20: The method of any of aspects 15 through 19, further comprising transmitting the communication or sensing data to an external system for real-time monitoring or coordination of multiple robotic vehicles in the operational environment.

Aspect 21: The method of any of aspects 15 through 20, wherein the plasmonic antenna is configured to transmit signals along conductive surfaces to facilitate communication in response to detecting non-line-of-sight conditions in the operational environment.

Aspect 22: The method of any of aspects 15 through 21, wherein the robotic vehicle includes a movable arm equipped with the plasmonic antenna to establish contact with surfaces in response to receiving control signals for sensing tasks.

Aspect 23: The method of any of aspects 15 through 22, wherein the communication module is configured to transmit signals indicative of detected dielectric properties to external systems for collaborative analysis of the operational environment.

Aspect 24: The method of any of aspects 15 through 23, wherein the plasmonic antenna is fabricated on a flexible substrate to conform to irregular surfaces of the robotic vehicle in response to structural constraints.

Aspect 25: The method of any of aspects 15 through 24, wherein the robotic vehicle is configured to deploy additional robotic vehicles equipped with plasmonic antennas to perform coordinated communication and sensing tasks in response to mission requirements.

Aspect 26: A system for using plasmonic antennas integrated with robotic vehicles for communication and sensing, comprising a processor; memory coupled with the processor; and instructions stored in the memory and executable by the processor to cause the system to perform a method of any of aspects 15 through 25.

Aspect 27: A system for using plasmonic antennas integrated with robotic vehicles for communication and sensing, comprising at least one means for performing a method of any of aspects 15 through 25.

Aspect 28: A non-transitory computer-readable medium storing code for using plasmonic antennas integrated with robotic vehicles for communication and sensing, the code comprising instructions executable by a processor to perform a method of any of aspects 15 through 25.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A system for plasmonic communications and sensing with robotic vehicles, comprising:
a plasmonic antenna configured to be mounted on a structure of a robotic vehicle, the structure of the robotic vehicle configured to position the plasmonic antenna at or near a surface, the plasmonic antenna configured to induce and/or capture surface electromagnetic waves propagating along the surface; and
a communication module operatively connected to the plasmonic antenna, the communication module configured to transfer and/or receive signals through the plasmonic antenna.

2. The system of claim 1, wherein the plasmonic antenna is fabricated on a flexible substrate, the flexible substrate configured to conform to a contour of the structure of the robotic vehicle.

3. The system of claim 1, wherein the plasmonic antenna includes copper strips, the copper strips configured to enhance the induction and/or capture of surface electromagnetic waves propagating along the surface.

4. The system of claim 1, further comprising a coaxial cable operatively connected to the communication module, the coaxial cable configured to transmit signals between the communication module and the plasmonic antenna.

5. The system of claim 1, wherein the structure of the robotic vehicle is configured to position the plasmonic antenna near conducting surfaces, the conductor surfaces configured to support the propagation of surface electromagnetic waves.

6. The system of claim 1, further comprising a tuning mechanism operatively connected to the plasmonic antenna, the tuning mechanism configured to adjust the operational frequency of the plasmonic antenna.

7. The system of claim 1, wherein the structure of the robotic vehicle includes a mounting location near conducting surfaces, the mounting location configured to position the plasmonic antenna to induce surface electromagnetic waves along the conductor surfaces.

8. The system of claim 1, wherein the plasmonic antenna is a flexible 433 MHz plasmonic antenna configured to operate with multiple radio systems to facilitate communication in environments with significant electromagnetic interference.

9. The system of claim 1, wherein the communication module is configured to analyze signals received by the plasmonic antenna to detect objects based on their dielectric properties.

10. The system of claim 1, wherein the plasmonic antenna is configured to transmit signals along a surface in response to the robotic vehicle encountering a non-line-of-sight scenario.

11. The system of claim 1, wherein the plasmonic antenna is configured to establish communication over a metal barrier in response to the robotic vehicle being positioned near the metal barrier.

12. The system of claim 1, wherein the plasmonic antenna operates in conjunction with one or more other plasmonic antennas to perform sensing tasks by inducing and/or receiving surface electromagnetic waves along a conductive surface to classify materials based on their dielectric properties.

13. The system of claim 1, wherein the plasmonic antenna is configured to be mounted near conducting surfaces to enable communication and sensing tasks in environments with significant free space signal attenuation.

14. A method for using plasmonic antennas integrated with robotic vehicles for communication and sensing, comprising:
receiving data indicative of a robotic vehicle's operational environment, the robotic vehicle including a plasmonic antenna mounted on a structure configured to contact a surface;
transmitting control signals to the robotic vehicle to activate the plasmonic antenna for surface electromagnetic wave propagation along the surface;
processing signals received from the plasmonic antenna to determine communication or sensing data associated with the operational environment; and
storing the communication or sensing data in a memory for subsequent analysis or use.

15. The method of claim 1, further comprising transmitting control signals to adjust a frequency of the plasmonic antenna based on the data indicative of the operational environment to facilitate surface electromagnetic wave propagation across varying material properties of the surface.

16. The method of claim 1, further comprising receiving additional data from onboard sensors of the robotic vehicle indicative of dielectric properties of objects in the operational environment and correlating the additional data with the signals received from the plasmonic antenna.

17. The method of claim 1, further comprising transmitting control signals to reposition the robotic vehicle to establish contact between the plasmonic antenna and a different surface in response to detecting a change in the operational environment.

18. The method of claim 1, further comprising processing the signals received from the plasmonic antenna to classify materials in the operational environment based on their electromagnetic response characteristics.

19. The method of claim 1, further comprising transmitting the communication or sensing data to an external system for real-time monitoring or coordination of multiple robotic vehicles in the operational environment.

20. A system configured for using plasmonic antennas integrated with robotic vehicles for communication and sensing, comprising:
a processor;
memory coupled with the processor; and
instructions stored in the memory and executable by the processor to cause the system to:
receive data indicative of a robotic vehicle's operational environment, the robotic vehicle including a plasmonic antenna mounted on a structure configured to contact a surface;
transmit control signals to the robotic vehicle to activate the plasmonic antenna for surface electromagnetic wave propagation along the surface;
process signals received from the plasmonic antenna to determine communication or sensing data associated with the operational environment; and
store the communication or sensing data in the memory for subsequent analysis or use.
